(19) United States
(12) Patent Application Publication
(10) Pub. No.: US 2016/0254666 A1
(43) Pub. Date: Sep. 1, 2016

(54) ADAPTIVE MICROGRID CONTROL

(71) Applicant: INTELLIGENT POWER & ENERGY RESEARCH CORPORATION (IPERC), Fort Montgomery, NY (US)

(72) Inventors: Peter S. CURTISS, Boulder, CO (US); Scott J. ROBERTS, Erie, CO (US)

(73) Assignee: INTELLIGENT POWER & ENERGY RESEARCH CORPORATION (IPERC), Fort Montgomery, NY (US)

(21) Appl. No.: 15/049,171

(22) Filed: Feb. 22, 2016

Related U.S. Application Data
(60) Provisional application No. 62/121,671, filed on Feb. 27, 2015.

(51) Int. Cl. H02J 3/00; G05B 15/02

(52) U.S. Cl. CPC H02J 3/00; G05B 15/02

(57) ABSTRACT

A method, system, and computer program product are provided for generating an automated control process for controlling a subsection of a utility grid of a power network. The method includes: determining a topology of the subsection of the utility grid by obtaining data describing functionalities of components of the subsection of the utility grid and relationships between the components; identifying an event type in the power network which will trigger a requirement for implementing a configuration change to the subsection; generating an automated control process for directing the configuration change in the subsection, should an event of the event type occur; and automatically distributing the automated control process to a controller associated with the power network. The controller monitors, at least in part, the power network, and initiates the configuration change using the automated control process based on identifying occurrence of the event of the event type.

### CROSS-REFERENCE TO RELATED APPLICATION

This application claims the benefit of U.S. Provisional Patent Application Ser. No. 62/121,671 filed Feb. 27, 2015, entitled “System Wide Adaptive Response Microgrid,” which is hereby incorporated by reference in its entirety.

### BACKGROUND

The increased prevalence of electricity distribution system leads to the increased interest in so-called smart grid technologies. The increased implementation and utilization of smart grid technologies in power networks has led to an increase in the number and type of power grid components that can accommodate computer interconnections, as well as the number of computing systems and components that communicate with such components.

The use of smart grid systems in power networks enables the decomposition of a large power grid into a set of smaller, autonomous, power networks, commonly referred to as microgrids. Many of these networks are connected to the public utility system, but during times of power outages or other reliability problems, the microgrids can disconnect, or “island” from the utility and dispatch local generators to satisfy the isolated power demands of resources within the microgrid. Benefits of the islanding process include resiliency of power in the local microgrid and also relief for the large, utility-wide power grid, because it no longer has to power components in the microgrid. Challenges for microgrids include overall control of the system to minimize fuel use in the local generators, while at the same time ensuring that the microgrid remains energized. These two conflicting goals are achieved by shedding non-critical electrical loads and curtailing/dispatching conventional generators according to the electrical demand. Additional issues that contribute to the complexity of managing microgrids include the use of intermittent renewable power sources and the uncertainties of user behavior.

### SUMMARY

Shortcomings of the prior art are overcome and additional advantages are provided through the provision of a method for generating an automated control process for controlling a subsection in a utility grid in a power network. The method includes, for instance: determining a topology of the subsection of the utility grid by obtaining data describing functionalities of components of the subsection of the utility grid and relationships between the components, wherein the subsection of the utility grid comprises one or more potential utility subgrids; identifying an event type in the power network which will trigger a requirement for implementing a configuration change to the subsection of the utility grid; generating, based on the topology, an automated control process for directing the configuration change in the subsection of the utility grid should an event of the event type occur; and automatically distributing to at least one controller associated with the power network the automated control process, wherein the at least one controller monitors, at least in part, the power network, and initiates the configuration change using the automated control process based on identifying occurrence of the event of the event type.

Shortcomings of the prior art are overcome and additional advantages are provided through the provision of a computer program product for generating an automated control process for controlling a subsection in a utility grid in a power network. The computer program product comprises a storage medium readable by a processing circuit and storing instructions for execution by the processing circuit for performing a method. The method includes, for instance: determining a topology of the subsection of the utility grid by obtaining data describing functionalities of components of the subsection of the utility grid and relationships between the components, wherein the subsection of the utility grid comprises one or more potential utility subgrids; identifying an event type in the power network which will trigger a requirement for implementing a configuration change to the subsection of the utility grid; generating, based on the topology, an automated control process for directing the configuration change in the subsection of the utility grid should an event of the event type occur; and automatically distributing to at least one controller associated with the power network the automated control process, wherein the at least one controller monitors, at least in part, the power network, and initiates the configuration change using the automated control process based on identifying occurrence of the event of the event type.

Shortcomings of the prior art are overcome and additional advantages are provided through a system for generating an automated control process for controlling a subsection in a utility grid in a power network, comprising: a utility grid in a power network comprising a subsection, the subsection comprising one or more potential utility subgrids, the subsection further comprising components; one or more processors in communication with one or more memories, the one or more processors configured to generate an automated control process for directing a configuration change in the subsection of the utility grid and to automatically distribute the automated control process at least one controller coupled to the power network, the generating the automated control process comprising: determining a topology of the subsection of the utility grid by obtaining data describing functionalities of components of the subsection of the utility grid and relationships between the components; identifying an event type in the power network which will trigger a requirement for implementing a configuration change to the subsection of the utility grid should an event of the event type occur; and generating, based on the topology, the automated control process; and the at least one controller configured to obtain the automated control process and to monitor, at least in part, the power network, and initiate the configuration change using the automated control process based on identifying an occurrence of the event of the event type.

Methods and systems relating to one or more aspects are also described and claimed herein. Further, services relating to one or more aspects are also described and may be claimed herein. Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and other objects, features, and advantages are apparent from the following detailed description taken in conjunction with the accompanying drawings in which:

FIG. 1 depicts a technical environment that can be controlled by various aspects of an embodiment of the present invention;

FIG. 2 depicts an example of a hardware configuration of a power network wherein the resources can be utilized by aspects of an embodiment of the present invention;

FIG. 3 is an exemplary workflow diagram of a method, in accordance with one or more aspects of the present invention;

FIG. 4 is an exemplary workflow diagram of a method, in accordance with one or more aspects of the present invention;

FIG. 5 is an exemplary workflow diagram of a method, in accordance with one or more aspects of the present invention;

FIGS. 6A-6B are an exemplary workflow diagram of a method, in accordance with one or more aspects of the present invention;

FIGS. 7A-7B are an exemplary workflow diagram of a method, in accordance with one or more aspects of the present invention;

FIGS. 8A-8B are an exemplary workflow diagram of a method, in accordance with one or more aspects of the present invention; and

FIG. 9 depicts one embodiment of computing node that can be utilized in one or more embodiments of the present invention.

### DETAILED DESCRIPTION

The accompanying figures, in which like reference numerals refer to identical or functionally similar elements throughout the separate views and which are incorporated in and form a part of the specification, further illustrate the present invention and, together with the detailed description of the invention, serve to explain the principles of the present invention. As understood by one of skill in the art, the accompanying figures are provided for ease of understanding and illustrate aspects of certain embodiments of the present invention. The invention is not limited to the embodiments depicted in the figures.

As understood by one of skill in the art, program code, as referred to throughout this application, includes both software and hardware. For example, program code in certain embodiments of the present invention includes fixed function hardware, while other embodiments utilize a software-based implementation of the functionality described. Certain embodiments combine both types of program code.

One or more aspects relate, in general, to automated control of functionality on power networks and specifically, generating an automated control process for controlling a subsection of a utility grid in a power network. In this application, stand-alone portions of utility grids in a power network are referred to interchangeably as subsections, subgrids, and microgrids.

Aspects of some embodiments of the present invention include a method, computer program product and system for generating an automated control process for controlling a subsection of a utility grid of a power network, including but not limited to one or more microgrids. Advantages of certain embodiments of the present invention include reduced microgrid installation cost, since much of the control work would be automated. In addition, the list of contingencies handed by automated control processes generated and implemented in embodiments of the present technique can be consistent and extensive, meaning that the resulting automated control processes would provide for contingencies that may have been overlooked in a manual process. Additionally, aspects of the present invention enable microgrid control processes to be controlled centrally, while implementation of configuration changes based on contingencies is now generally completed both manually and locally.

To this end, in one aspect of certain embodiments of the present invention, program code determines a topology of the subsection of the utility grid by obtaining data describing functionalities of components of the subsection of the utility grid and relationships between the components. This subsection of the utility grid may include one or more potential utility subgrids. The components of the subsection may include, but are not limited to: a power source, a power load, a switchgear, and/or an energy storage system.

In an embodiment of the present invention, the program code identifies a type of event in the power network, which will trigger a requirement for implementing a configuration change to the subsection of the utility grid. This configuration change may include, but is not limited to, islanding the subsection, reconnecting the subsection to a utility, and/or changing the functionality and connectivity of individual components of the subsection. Based on the topology, the program code generates an automated control process for directing the configuration change in the subsection of the utility grid, should an event of the event type occur, and automatically distributes the control process to at least one controller associated with the power network. By distributing the automated control process to at least one controller monitor, the controller can, which monitors components of the power grid, can initiate the configuration change using the automated control process, based on identifying occurrence of the event of the event type in the power network.

In an embodiment of the present invention, the program code determines the topology of the subsection of the utility grid by analyzing the aforementioned obtained data to determine if the obtained data is sufficient to generate the automated control process for the subsection of the utility grid. In order to make this determination, in an embodiment of the present invention, the program code may ascertain that the obtained data includes rated capacities of the components of the subsection of utility grid, that the obtained data includes identifications of communication protocols and datastreams of the components, and/or that the subsection of utility grid is allocated breakers operable for load isolation, grounding, and islanding, based on the configuration change in the automated control process applied to the subsection of the utility grid. In an embodiment of the present invention, in order to determine that the data obtained is sufficient, the program code ascertains that each component in the subsection is associated with one or more electrical conductors in the subsection of utility grid and/or ascertains that external controllers in the subsection of utility grid can be managed by the at least one controller.

In an embodiment of the present invention, the event that triggers the automated process to make the configuration changes may be one or more of an actual or expected loss of voltage, restoration of voltage, or a change in load in the power network. For instance, the event may be a result of an operation change to a power load in the subsection of the utility grid.

In various embodiments of the present invention, the program code may make different configuration changes when executing an automated control process. The configuration change triggered by an event of the identified event type may include: the program code opening a breaker to disconnect the subsection of the utility grid from at least one utility feeder in the power network or the program code closing a breaker to connect the subsection of the utility grid to at least one utility feeder in the power network. In another aspect of the present invention, the configuration change may include the program code enabling or disabling a component of the subsection of the utility grid. In a further aspect, the program code may enable or disable a power source.

When the configuration change includes opening a breaker, in an embodiment of the present invention, the configuration change may further include the program code tripping one or more load breakers in the subsection of the utility grid, the program code starting one or more local generators in the subsection of the utility grid, and/or the program code monitoring power generation of the one or more local generators to verify that the one or more potential utility subgrids in the subsection of the utility grid are operational.

When the configuration change includes closing a breaker, in an embodiment of the present invention, the configuration change may further include the program code stopping one or more local generators in the subsection of the utility grid, the program code monitoring one or more power generators of the local generators to verify that the one or more power generators have stopped, and/or based on this verifying, the program code closing one or more load breakers in the subsection of the utility grid to reconnect components in the subsection of the utility grid.

In an embodiment of the present invention, the program code provides for a customizable graphic user interface so that the a system operator (user) has access to a visualization of what the subsection of the utility grid is doing, including how the automated control processes deployed by the controller are affecting the operation of the components of the subsection.

The control systems for microgrids today are typically custom designs that address the specific equipment in the system and the proper control of the microgrid as a whole is critical to the success of the system. This can be problematic when the physical system changes through the addition or removal of generation sources and/or there is a change in the customer loads or demand patterns. Presently, because of the variation between microgrids, the control processes to change the operation of microgrids based on certain events, e.g., islanding the microgrid, re-connecting a previously islanded microgrid to a main utility, operating in islanded mode, and handling contingencies that impact the functionality of the microgrid, are largely manual, are performed remotely rather than being centralized, and rely upon a great deal of trial and error.

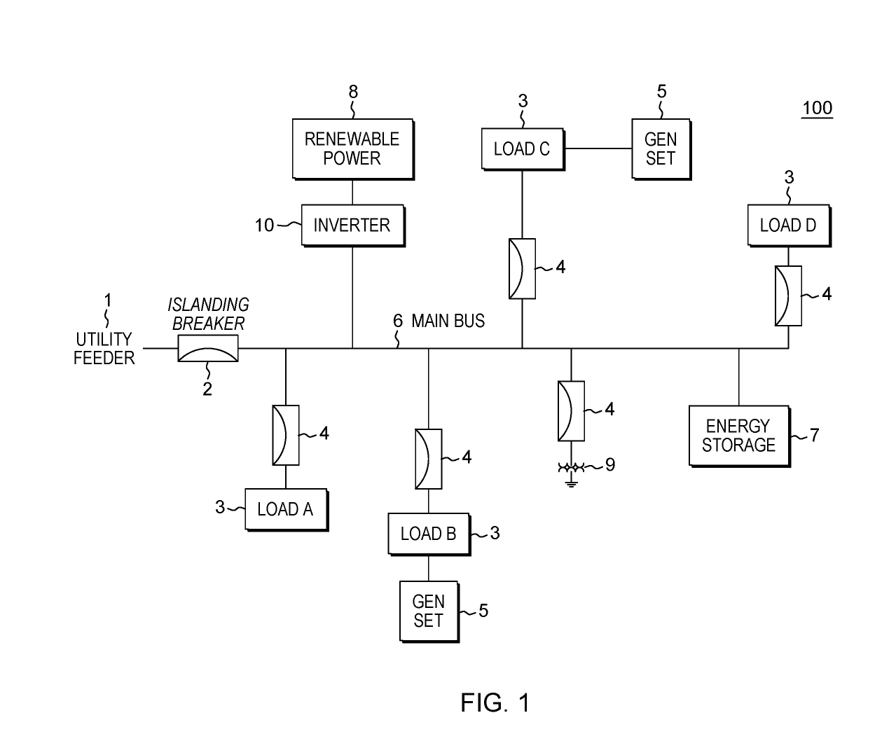

FIG. 1 is an example of a microgrid 100 (e.g., a subsection of a utility grid) that the program code in an embodiment of the present invention would obtain information about in order to generate an automated control process for implementing configuration changes to the microgrid 100 in order to handle a given event. Once the program code generates the automated control process, the program code distributes this automated control process to at least one controller communicatively coupled to one or more resources on the microgrid 100, such that this at least one controller could deploy the automated control process to the resources of the microgrid 100 and thus, initiate certain configuration changes as dictated by the automated control process.

As understood by one of skill in the art, the microgrid 100 of FIG. 1 is only one example of a possible configuration and composition for a microgrid 100. As such, FIG. 1 includes some basic components of a microgrid 100. This non-limiting example of a microgrid 100 is utilized for illustrative purposes to depict the functionality of certain embodiments of the present invention.

In an embodiment of the present invention, the program code can reconfigure the components of the microgrid 100 when executing the automated control processes. In FIG. 1, the microgrid 100 includes an islanding breaker 2. When executing an automated control process, the program code opens islanding breaker 2 to interrupt the power flow to the microgrid 100 by disconnecting the microgrid 100 from a utility feeder 1 in the power network and closes islanding breaker 2 to connect the microgrid 100 to the utility feeder 2 in the power network.

As will be explained in greater detail, the program code generates automated control processes that enable the microgrid 100 to function subsequent to the occurrence of an event in the power network, such as a change in voltage, while also preventing the event from damaging the components of the microgrid 100. For example, when the program code implements a change in the grid by executing an automated control process, the automated control process may include steps for ensuring the continuity or shedding of the loads 3, in FIG. 1, Load A, Load B, Load C, and Load D. Certain of the loads include generator sets 5, which the program code can utilize, as part of the automated control process to power the microgrid 100 as a whole, or just the loads 3 to which they are directly connected, by opening or closing load breakers 4 that could isolate the generator sets 5 and their loads 3 from the remaining components of the microgrid 100. An example of a load 3 and generator set 5 that the automated control process may isolate would be a hospital and its respective generator. In some microgrids, the loads 3 are connected directly to a main bus 6 on the microgrid 100, but in some cases, line in FIG. 1, loads 3 can be disconnected from the microgrid 100 through the use of load breakers 4.

Other parts of the microgrid 100 that the program code would manage using an automated control process subsequent to an event include a grounding reference 9. For example, when an event dictating the islanding of a microgrid 100 occurs in a power network, the program code, when executing an automated control process, may close a breaker 4 connected to a grounding reference 9, so that the grounding reference 9 would enable the grounding of the microgrid 100 components. Additionally, the automated control process may enable the microgrid 100 to utilize energy storage 7, which, may be, for example, a battery or a flywheel. Program code executed as part of an automated control process may also dictate steps for configuring inverter 10 to utilize renewable power 8 to meet the demand of the loads 3 of microgrid 100, for example. The program code may utilize the renewable power 8 to meet the power requirement of certain loads 3 when the program code opens the islanding breaker 2 and interrupts the power flow from the utility feeder 1, for example, in the event of a power outage.

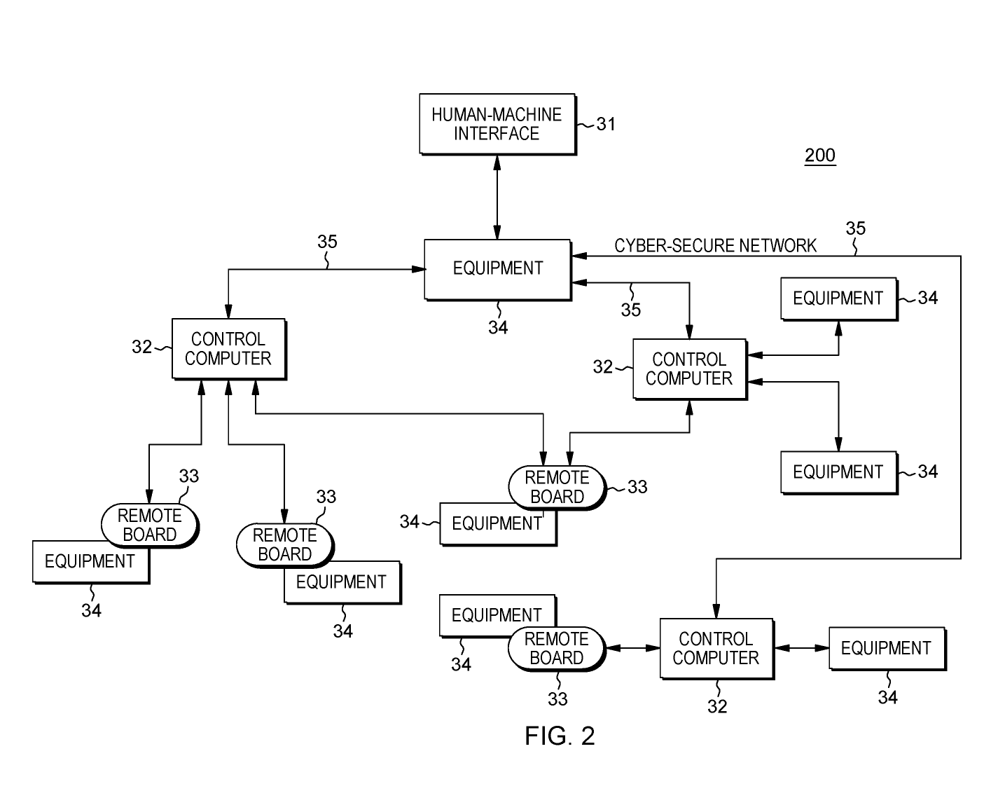

FIG. 2 depicts an example of a hardware configuration of a power network 200 that can be utilized, in an embodiment of the present invention, to generate and to distribute automatically automated control processes to equipment 34 (referred to interchangeably as components) within a power network 200. In order to maintain connectivity with equipment 34 throughout the power network 200, even in the event of an outage that may sever certain connections, control computers 32 are distributed throughout the power network. In an embodiment of the present invention, the program code can distribute automated control processes to these control computers 32, which can subsequently initiate configuration changes to the equipment 34 using the automated control processes, based on identifying occurrences of certain events in the power network 200. To access certain equipment 32, these control computers 32 may utilize remote boards 33 coupled to the equipment 34 as the remote boards 33 can extend the communications of the control computers 32 and provide some degree of redundancy within the power network 200. The hardware in a power grid may also include a human interface machine 31, which is a computing node that includes a graphical user interface and enables a user to observe activities and events within the power network 200. As will be discussed in this paper, some automated control processes generate data, including descriptions, for display to a user in a graphical user interface. In FIG. 2, the computing node with a graphical user interface is coupled to the power network 200 via a cyber-secure network 35.

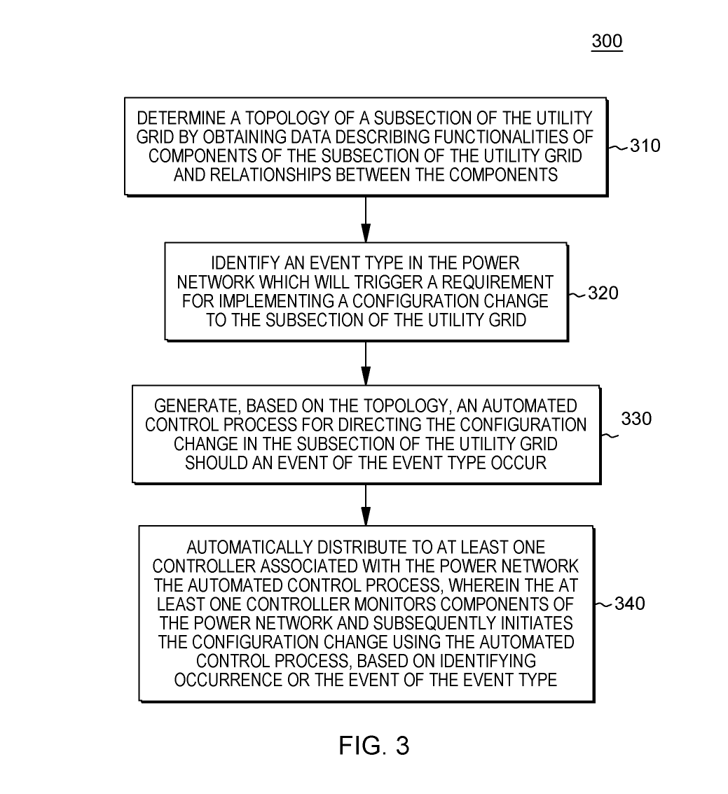

FIG. 3 illustrates a workflow for generating automated control processes and distributing these automated control processes, in accordance with certain aspects of embodiments of the present invention. In order to illustrate this workflow effectively, reference are made to elements of FIG. 1 and FIG. 2, these references are offered merely as non-limiting examples.

Referring to FIG. 3, program code determines a topology of a subsection of the utility grid by obtaining data describing functionalities of components of the subsection of the utility grid and relationships between the components (310). This subsection of the utility grid may be a microgrid 100 (FIG. 1), or a subsection of this microgrid, for example, a coupled load 3 (FIG. 1) and generator set 5 (FIG. 1). As illustrated in FIG. 1, the components may comprise loads 3, generator sets 5, energy storage 7, and renewable power sources 9.

In order to obtaining data about the components, the program code may utilize techniques such as described in U.S. Pat. No. 8,447,707 entitled “Automated control of a power network using metadata and automated creation of predictive process models,” and/or in U.S. Patent Publication No. 2015/0142197 A1, entitled “Automated Identification of Components Connected in a Power Grid,” both of which are hereby incorporated herein by reference in their entirety. For instance, U.S. Pat. No. 8,447,707 describes how information about the equipment (i.e., components) in a power grid is contained in descriptions of the equipment as well as in data streams used for monitoring that equipment. For example, a generator might have a measurement related to its power output, but the description of that power data stream would also include the expected range of that measurement (i.e., the rated capacity of the generator). These data stream metadata can also include physical location of the devices and what other components it is connected to, controlled by, and reliant upon.

To understand how the data stream metadata are used for automatic configuration of a microgrid, it is instructive to consider the basic steps for getting into islanded mode (also referred to as microgrid mode): (1) disconnect the microgrid from the utility, (2) trip all the load breakers, (3) isolate and start the on-site power sources, (4) establish a local ground reference if necessary, (5) sequentially connect the power sources to the microgrid, and (6) reclose the load breakers in a prioritized order without overwhelming the existing generation capacity. The use of additional data stream metadata allow for the automatic identification of the microgrid components that participate at each step. This is possible by describing different attributes of each component, so that, for example, a breaker can have the attribute of being a utility islanding breaker, a low-priority load isolation breaker, etc. This generic treatment of all the observed equipment in the system allows for the automatic creation of control algorithms.

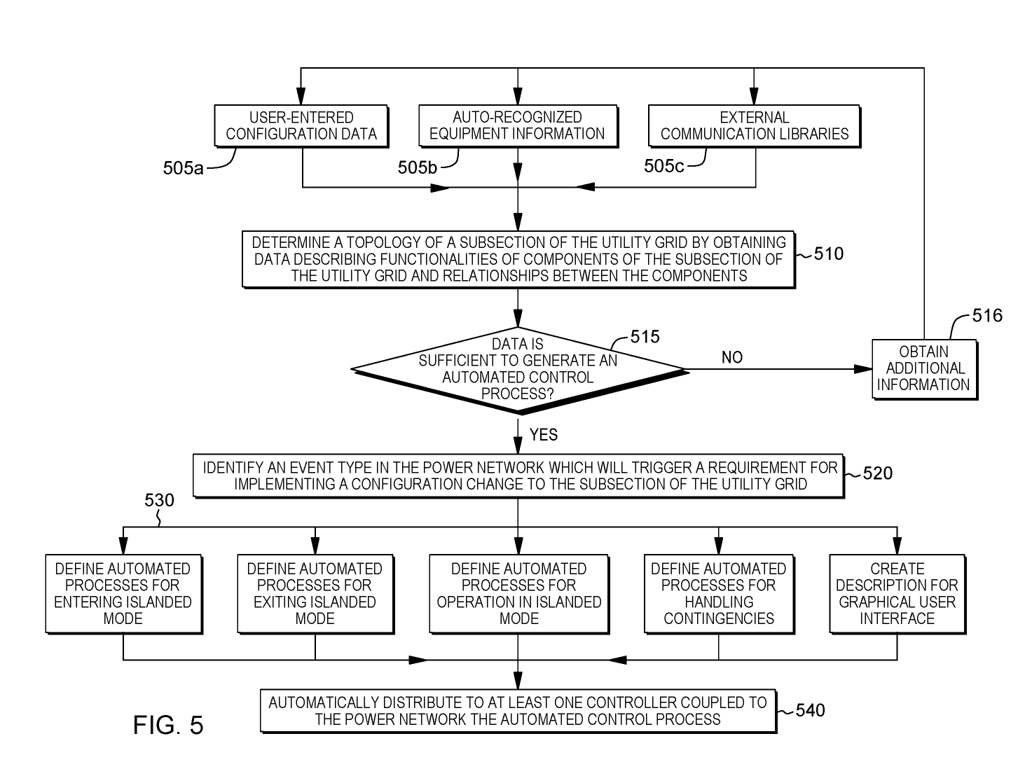

FIG. 5, which will be discussed in greater detail later on, illustrates various sources of the data describing functionalities of components of the subsection of the utility grid and relationships between the components that the program code utilizes to determine the topology of a subsection of the utility grid (310, FIG. 3). FIG. 5 illustrates that this data may include user-entered configuration data 505a, auto-recognized equipment information 505b, and external communication libraries 505c. Thus, the program code may use both human input and so-called “smart” data streams (i.e., data streams with metadata) to determine the topology of a subsection of the utility grid. User-entered information may be helpful due to the presence of older equipment that does not support computer querying or due to equipment topology that is sufficiently complicated that it requires a human description. The program code may also obtain this data by executing direct computer queries to the various components of the power network. In some instances, the program codes obtains data by utilizing an automatic control configuration tool that employs a number of communication libraries that contain the basic data maps for a wide variety of equipment using any number of known protocols (Modbus, CANbus, DNP3, etc.), so that the queries can be executed without much a priori knowledge of the components.

Returning to FIG. 3, the program code may determine a topology of a subsection of the utility grid (310) by evaluating the data obtained to determine the physical relationship of each component, including where each component is located electrically with respect to the other components in the subsection. This topology analysis may include analyses of power sources, power loads, switchgear, and energy storage systems.

Referring to FIG. 3, the program code identifies an event type in the power network which will trigger a requirement for implementing a configuration change to the subsection of the utility grid (320). The event type may include an event that is characterized by, for instance, a loss of voltage, a restoration of voltage, or change in load, in the power network. The program code may determine that an event has occurred, for example, by a control computer 32 (FIG. 2) monitoring power from a utility feeder 1 (FIG. 1) to other components of a microgrid 100 and/or to the equipment 34 (FIG. 2) in a power network (200).

Referring to FIG. 3, the program code generates, based on the topology, an automated control process for directing the configuration change in the subsection of the utility grid should an event of the event type occur (330). For example, the program code may determine that when there is a loss or restoration of voltage in the power network (the event), the configuration change implemented through an automated control process should include one of: opening a breaker (e.g., islanding breaker 2, FIG. 1) to disconnect the subsection of the utility grid (e.g., microgrid 100, FIG. 1) from at least one utility feeder 1 (FIG. 1) in the power network, or closing a breaker (e.g., islanding breaker 2, FIG. 1) to connect the subsection of the utility grid to at least one utility feeder in the power network.

Referring to FIG. 1, in an embodiment of the present invention, in the event that the configuration change includes opening a breaker (e.g., islanding breaker 2), the automated control process may implement additional configuration changes such that the subsection of the utility grid (e.g., microgrid 100) can effectively island the subsection. For example, the configuration change may also include tripping load breakers 2 in the subsection of the utility grid, starting local generators (e.g., generator sets 5) in the subsection of the utility grid, and monitoring power generation of the local generators to verify that the one or more potential subgrids (e.g., Load C and the generator set 5 to which it is directly connected) in the subsection of the utility grid are operational.

As illustrated with the assistance of FIG. 1, in the event that the configuration change includes closing a breaker (e.g., islanding breaker 2), the automated control process may implement additional configuration changes in order to enable the subsection of the utility grid (e.g., microgrid 100) to safely exit islanded mode. For example, the configuration change implemented in the automated control process may include stopping local generators (e.g., generator sets 5) in the subsection of the utility grid, monitoring power generation of the local generators to verify that generators have stopped, and based on the verifying, closing load breakers 2 in the subsection of the utility grid to reconnect components in the subsection of the utility grid.

In addition to generating automated control processes to place microgrids in islanded mode and to remove microgrids from islanded mode, automated control processes may also handle contingencies that dictate isolated changes to certain components within a microgrid. For example, an automated control process deployed to handle an event (e.g., an actual or expected loss of voltage, restoration of voltage, or change in load) may implement a configuration change that includes enabling or disabling a component of the microgrid. Components in a microgrid include, but are not limited to, a power source, a power load, a switchgear, and/or an energy storage system. Thus, for example, the event that triggers an automated control process may result from an operation change to a power load in the microgrid, such as shedding a load, and in response to this event, the program code executing an automated control process may enable or disable a power source, such as starting a generator.

Returning to FIG. 3, in an embodiments of the present invention, the program code automatically distributes the automated control process to at least one controller associated with the power network and the at least one controller monitors and subsequently initiates the configuration change using the automated control process, based on identifying occurrence of the event of the event type (340). As aforementioned, the power network 200 of FIG. 2 illustrates how control computers 32 can be distributed throughout the power network 200 and can be utilized, in embodiments of the present invention, to generate automated control processes, to distribute these automated control processes to other control computers 32 on the power network 200, to monitor the equipment 34 on the power network 200, and to deploy the automated control processes to the equipment 34, based on identifying occurrence of an event.

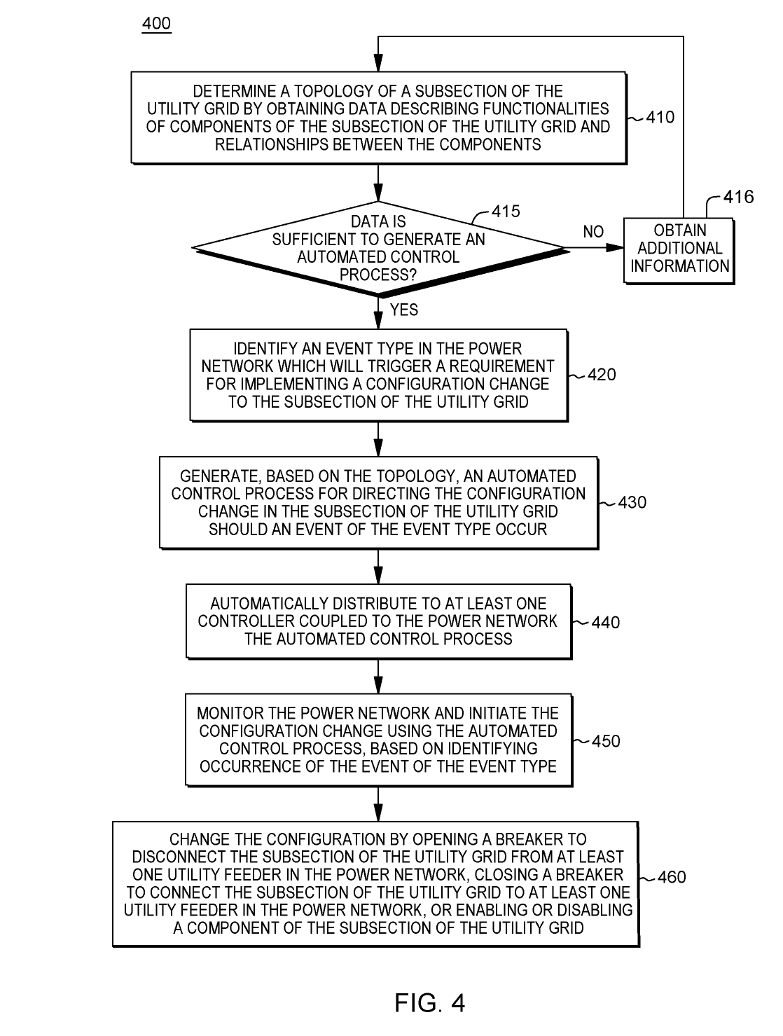

FIG. 4 depicts a workflow 400 of another embodiment of the present invention. In an embodiment of the present invention, the program code determines a topology of a subsection of the utility grid by obtaining data describing functionalities of components of the subsection of the utility grid and relationships between the components (410). The program code then determines if the data obtained is sufficient to generate an automated control process (415). If the program code determines that there is not sufficient information to proceed, the program code obtains additional information (416), through methods including, but not limited to, querying a user through an interview-like process through a graphical user interface to fill in the data gaps. When making this determination, the program code may ascertain information, including but not limited to, that the obtained data comprises rated capacities of the components of the subsection of utility grid, that the obtained data comprises identifications of communication protocols and datastreams of the components, that the subsection of utility grid is allocated breakers operable for load isolation, grounding, and islanding based, on the configuration change applied to the subsection of the utility grid, that each component is associated with one or more electrical conductors in the subsection of utility grid, and/or that external controllers in the subsection of utility grid can be managed by the at least one controller.

Referring to FIG. 4, in an embodiment of the present invention, based on, in part, having sufficient data to determine the physical relationship of each microgrid component, that is, where each component is located electrically with respect to the other components, the program code identifies an event type in the power network which will trigger a requirement for implementing a configuration change to the subsection of the utility grid (420). The program code generates, based on the topology, an automated control process for directing the configuration change in the subsection of the utility grid, should an event of the event type occur (430). The program code automatically distributes the automated control process to at least one controller coupled to the power network (440). The program code, including by not limited to program code executing on the at least one controller, monitors the power network and initiates the configuration change using the automated control process, based on identifying occurrence of the event of the event type (450). Program code then changes the configuration by opening a breaker to disconnect the subsection of the utility grid from at least one utility feeder in the power network, closing a breaker to connect the subsection of the utility grid to at least one utility feeder in the power network, or enabling or disabling a component of the subsection of the utility grid (460).

As aforementioned, FIG. 5, another workflow 500 depicting aspects of certain embodiments of the present invention, illustrates that the program code obtains data describing functionalities of components of the subsection of the utility grid and relationships between the components to determine a topology of a subsection of the utility grid (510) from sources, including but not limited to, user-entered configuration data 505a, auto-recognized equipment information 505b, and external communication libraries 505c. In this embodiment, upon the program code determining that the data obtained is sufficient to generate an automated control process (515) (obtaining additional information, if needed (516)) and identifying an event type in the power network which will trigger a requirement for implementing a configuration change to the subsection of the utility grid (520), the program code generates, based on the topology, an automated control process for directing the configuration change in the subsection of the utility grid, should an event of the event type occur (530). As illustrated in FIG. 5, in differing embodiments of the present invention, the automated control processes can differ. FIG. 5 illustrates that the program code may define an automated control process for entering islanded mode, define an automated control process for exiting islanded mode, define an automated control process for operating in islanded mode, define an automated control process for handling contingencies, and/or create a description of power network activity for use in a graphical user interface (530). Upon generation of the automated control process, regardless of the type, the program code automatically distributes the automated control process to at least one controller associated with the power network (540).

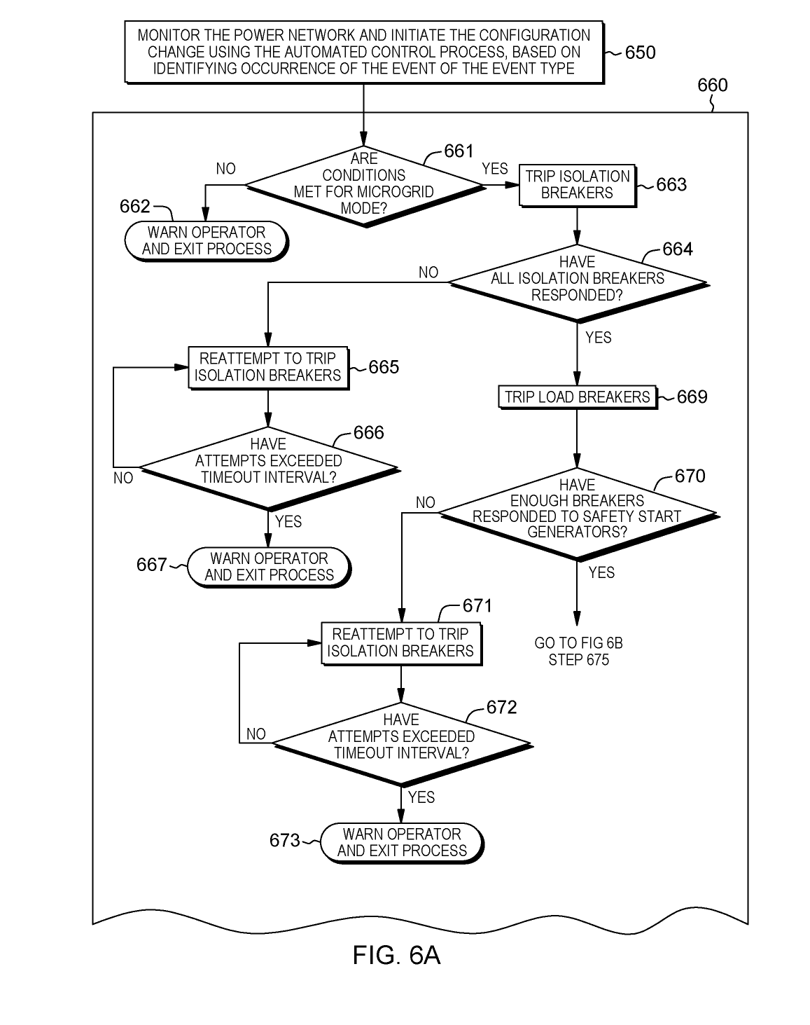

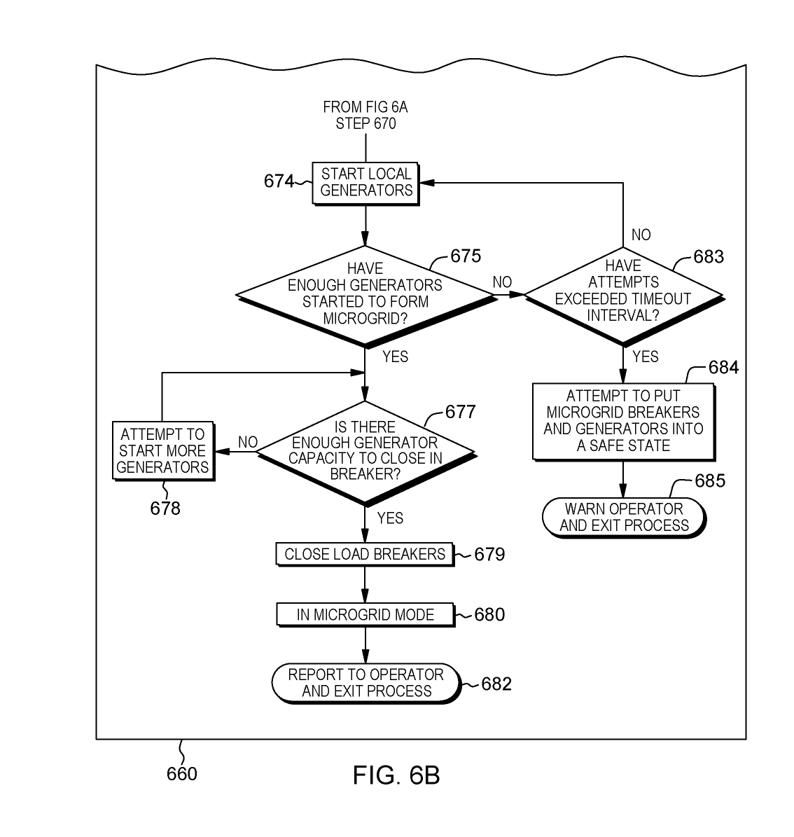

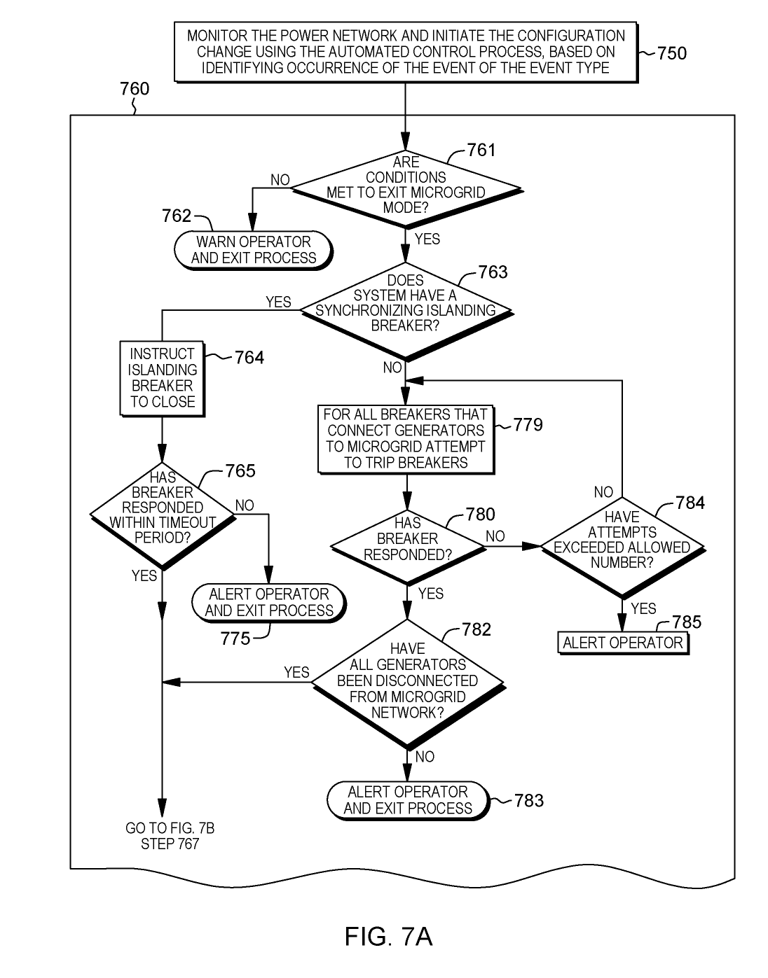

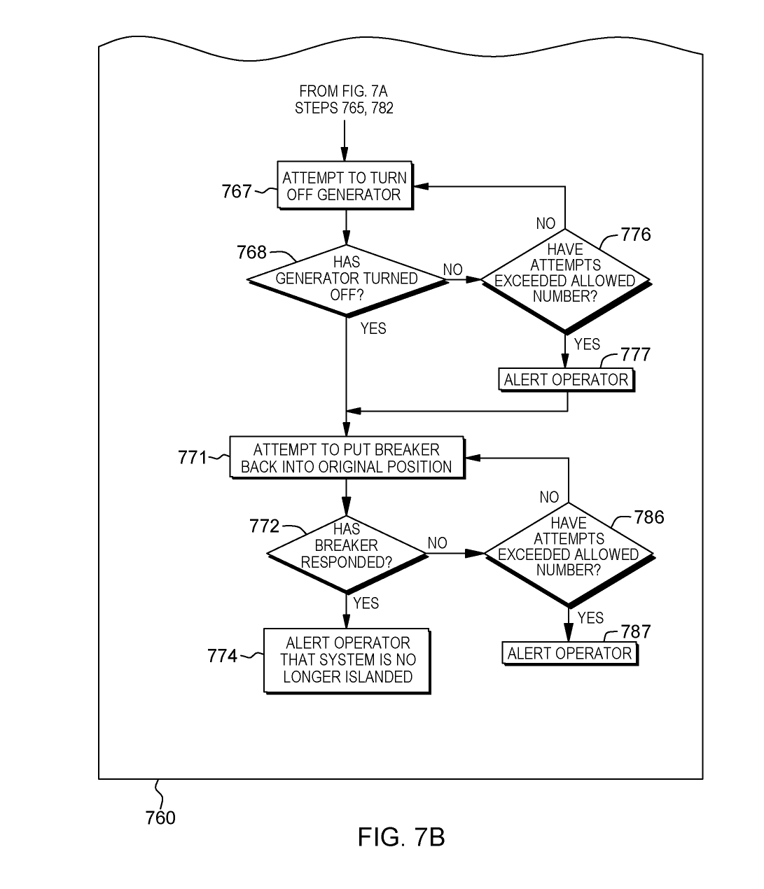

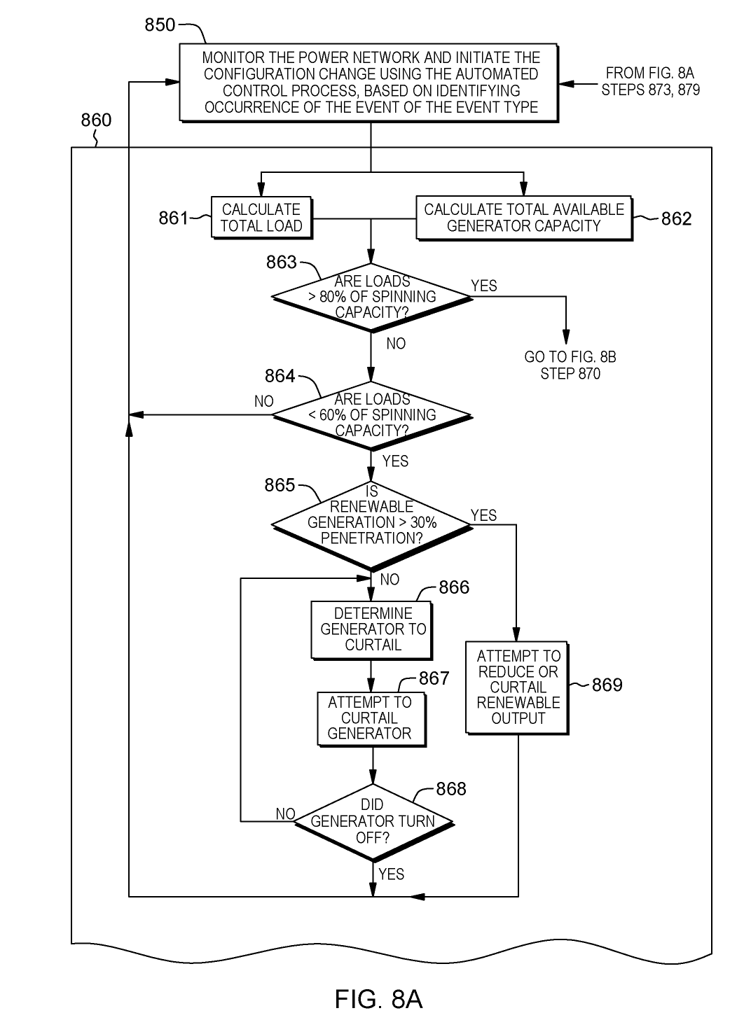

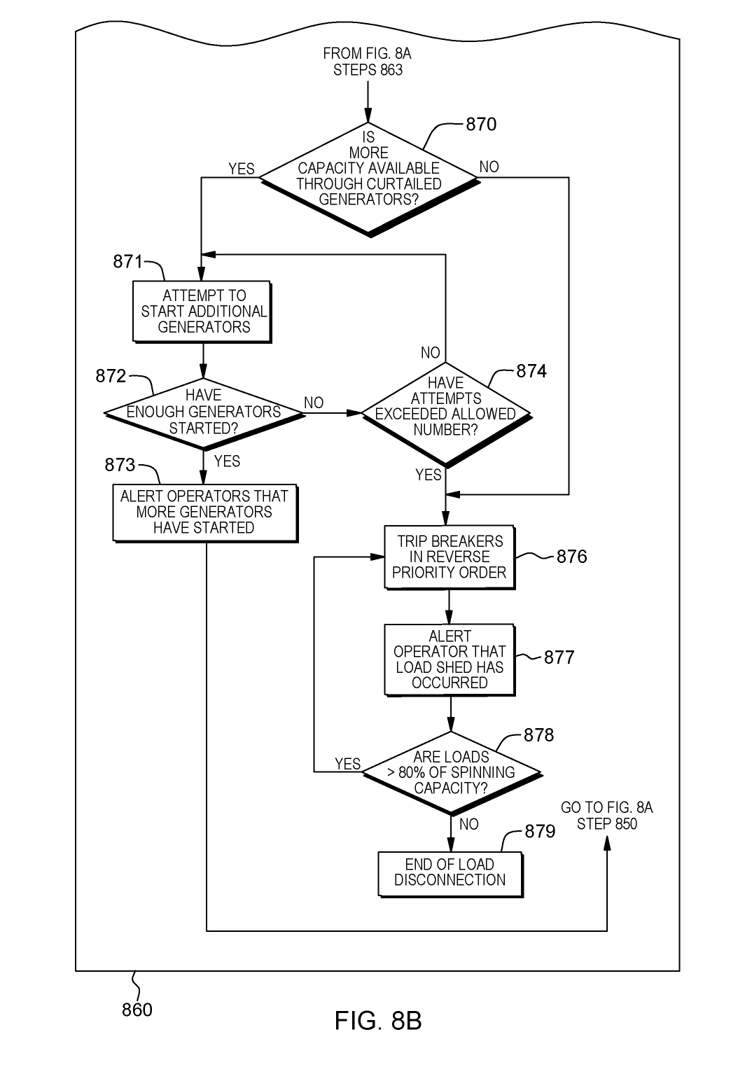

After a controller receives an automated control process, it can utilize it to initiate configuration changes in a subsection of the utility grid, when an event of an appropriate event type that would necessitate the process occurs. FIGS. 6A-8B provide details for certain of the automated control processes, when program code implements the configuration changes that comprise these processes. FIGS. 6A-6B depict an example of an automated control process for placing the subsection in an islanded mode, FIGS. 7A-7B depict an example of an automated control process for exiting an islanded mode, and FIG. 8A-8B depict an automated control process for operating in islanded mode.

Turning first to FIGS. 6A-6B, the program code selectively executes an automated control process for placing the subsection in an islanded mode (also called microgrid mode) 660. In operation, the program code, including but not limited to program code executing on the at least one controller, monitors the power network and initiates a configuration change using the automated control process, based on identifying occurrence of an event of the event type that would trigger this automated control process (650). The program code then evaluates whether the conditions are met for entering microgrid mode (for islanding the subsection) (661). If the conditions are not met, the program code exits the process and may warn an operator (662), for example, through the aforementioned graphical user interface (31, FIG. 2).

Provided that the conditions are met, the program code opens (trips) the isolation breaker (e.g., islanding breaker 2, FIG. 1) (663). The program code determines if the isolation breaker responded (664). If the program code determines that the isolation breaker has not responded, the program code may attempt to trip the breaker again (665) and possibly repeatedly at intervals (666), until, for example, a number of attempts is exceeded or a given interval lapses, at which point, the program code may exit the process and warn the user (667).

Provided tripping the isolation breaker was successful, the program code then trips certain of the load breakers (e.g., 4, FIG. 1) (669). The program code then determines whether enough breakers have responded to safely start generators (670). If the program code determines that enough load breakers have not responded, the program code may attempt to trip the breakers again (671) and possibly repeatedly at intervals (672), until, for example, a number of attempts is exceeded or a given time interval lapses, at which point, the program code may exit the process and warn the user (673).

Alternatively, if the program code determines that enough (e.g., a predetermined number and/or a specific group, etc.) of load breakers have responded, the program code may start local generators (e.g., generator set 5, FIG. 1) (674). The program code determines if enough generators have started to island the subsection to form the microgrid (675). If not, the program code continues attempting to start local generators until a number of attempts is exceeded or a given interval lapses (683). Once this threshold is exceeded, the program code places the breakers in the subsection and the generators into a safe mode (684) and warns the user and exits the process (685).

If the program code determines that enough generators have started (675), the program code then determines if enough generators have started to close load breakers and supply power to the loads in the subsection (677). Thus, for each of the loads (e.g., load 3, FIG. 1) in the program code determines is there is enough generator capacity to close the load breakers to enable the power to be supplied to each load (677). If there is enough capacity to close the load breakers, the program code closes the load breakers (679), placing the subsection in microgrid mode (680) and then, in certain embodiments of the present invention, reporting the mode shift to a user and exiting the process (682). If there is not enough capacity, the program code attempts to start additional generators in order to meet capacity (678).

Turning now to FIGS. 7A-7B, these figures depict an automated control process for exiting an islanded mode 760. In operation, the program code, including, but not limited to, program code executing on the at least one controller (e.g., control computer 32, FIG. 2), monitors the power network and initiates the configuration change using the automated control process, based on identifying occurrence of a qualifying event, i.e., an event that would trigger this particular automated control process (750). The program code then determines whether conditions have been met, for example, if the qualifying event has occurred, to exit islanded mode (also referred to as microgrid mode) (761). If the conditions are not met, the program code alerts the user and exits the process (762).

Provided that the conditions are met, the program code then determines if the system has a synchronizing islanding (e.g., islanding breaker 2, FIG. 1) (763). If there is an islanding breaker, the program code instructs it to close (764) and if the program code determines that the breaker has not responded within a predetermined period (765), the program code alerts a user (775). If the program code determines that the breaker has responded within a predetermined period (765), the program code attempts to turn off the generators in the subsection (767). In the event the generators do not turn off and attempts by the program code to turn them off have exceeded an allowed number of attempts (776), the program code alerts the user (777). Otherwise, after successfully turning off the generators, the program code attempts to restore the load breakers to their positions from before the subsection was islanded, whether that means opening or closing the breakers (771). Provided that the breakers respond (772), the program code can alert the user that the subsection is no longer islanded (774). In the event that the breakers do not respond and attempts have exceeded an allowed number (786), the program code alerts the user (787).

In the event that the program code determines that a previously islanded subsection does not have a synchronizing islanding breaker (763), the program code attempts to trips the breakers that connect the subsection to the generators in the subsection (779). In the event the breakers do not respond and attempts have exceeded an allowed number (784), the program code alerts the user (785). Once the breakers have responded, the program code determines whether all generators have been disconnected from the subsection (which may also be referred to as a microgrid network) (782). If they have not, the program code alerts the user (783). If they have, the program code proceeds with attempting to turn off generators (767) and the subsequent portions of this automated control process which have been previously described.

As aforementioned, FIG. 8 depicts an example of an automated control process for operating in islanded mode 860, in accordance with aspects of an embodiment of the present invention. This automated control process manages the ratio of the demand for the loads, to the power generation by the generators and other power sources, such that portion of the subsection can operate efficiently and are not damaged during microgrid mode.

In operation, the program code, including by not limited to program code executing on the at least one controller, monitors the power network and initiates the configuration change using the automated control process, based on identifying occurrence of the event of the event type (850). The program code calculates the load total for the subsection (861) and calculates the total availability and generator capacity (862) for the subsection. The program code then determines if the loads are exceeding a given capacity, in this example, greater than 80% spinning capacity (863). If not, the program code determines if the loads are at less than 60% capacity (for example) (864). If not, the program code may alert the user of this development (873). If so, the program code can determine whether capacity in available from other power sources, for example, by checking if renewable energy (renewable power 8, FIG. 1) is at greater than, for example, 30%, penetration (865). If so, the program code may attempt to reduce or curtail the renewable output (869). As indicated in FIG. 8, this program code can repeat this curtailing process. If the penetration of the renewable energy does not exceed the threshold, the program code determines which generator to curtail (866), attempts to curtail the generator (867) and checks whether the generator turned (868). The program code may repeat this curtailing process, per FIGS. 8A-8B.

If the program code determines that the loads are exceeding a given capacity (863), the program code checks whether more capacity is available by utilizing curtailed generators (870). If there is availability, the program code attempts to start the generators (871) and if the program code determines that enough generators have started (872), the program code alerts the user that the generators have started (873). In the case that either no curtailed generators are available or the program code cannot start enough generators (872), with attempts having exceeded a timeout interval (874), the program code trips all load breakers in the subsection in reverse priority order (876), alerts the user that the load shed has occurred (877) until the program code determines that the loads are no longer at greater than 80% of the spinning capacity (878) and stops disconnecting loads by tripping breakers (879).

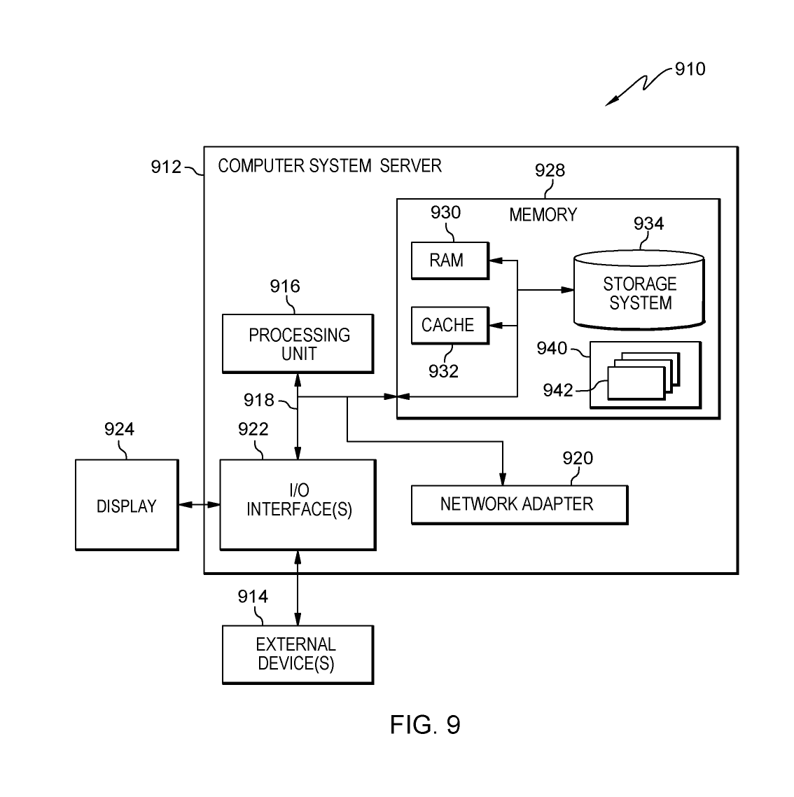

As seen in FIG. 2, the power network into which aspects of certain embodiments of the present invention are implemented, may include various computing nodes, for example, a human machine interface 31 and the control computers 32. FIG. 9 is an example of a computing node that may comprise one or more of these resources. In FIG. 9, computer system/server 912 in computing node 910 is shown in the form of a general-purpose computing device. The components of computer system/server 912 may include, but are not limited to, one or more processors or processing units 916, a system memory 928, and a bus 918 that couples various system components including system memory 928 to processor 916.

Bus 918 represents one or more of any of several types of bus structures, including a memory bus or memory controller, a peripheral bus, an accelerated graphics port, and a processor or local bus using any of a variety of bus architectures.

Computer system/server 912 typically includes a variety of computer system readable media. Such media may be any available media that is accessible by computer system/server 912, and it includes both volatile and non-volatile media, removable and non-removable media.

System memory 928 can include computer system readable media in the form of volatile memory, such as random access memory (RAM) 930 and/or cache memory 932. Computer system/server 912 may further include other removable/non-removable, volatile/non-volatile computer system storage media. By way of example only, storage system 934 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 918 by one or more data media interfaces. As will be further depicted and described below, memory 928 may include at least one program product having a set (e.g., at least one) of program modules that are configured to carry out the functions of embodiments of the invention.

Program/utility 940, having a set (at least one) of program modules 942, may be stored in memory 928 by way of example, and not limitation, as well as an operating system, one or more application programs, other program modules, and program data. Each of the operating system, one or more application programs, other program modules, and program data or some combination thereof, may include an implementation of a networking environment. Program modules 942 generally carry out the functions and/or methodologies of embodiments of the invention as described herein.

Computer system/server 912 may also communicate with one or more external devices 914 such as a keyboard, a pointing device, a display 924, etc.; one or more devices that enable a user to interact with computer system/server 912; and/or any devices (e.g., network card, modem, etc.) that enable computer system/server 912 to communicate with one or more other computing devices. Such communication can occur via Input/Output (I/O) interfaces 922. Still yet, computer system/server 912 can communicate with one or more networks such as a local area network (LAN), a general wide area network (WAN), and/or a public network (e.g., the Internet) via network adapter 920. As depicted, network adapter 920 communicates with the other components of computer system/server 912 via bus 918. It should be understood that although not shown, other hardware and/or software components could be used in conjunction with computer system/server 912. Examples, include, but are not limited to: microcode, device drivers, redundant processing units, external disk drive arrays, RAID systems, tape drives, and data archival storage systems, etc.

The computer program product may include a computer readable storage medium (or media) having computer readable program instructions thereon for causing a processor to carry out aspects of the present invention. In one example, a computer program product includes, for instance, one or more non-transitory computer readable storage media to store computer readable program code means, logic and/or instructions thereon to provide and facilitate one or more embodiments. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

Although various embodiments are described above, these are only examples. For example, computing environments of other architectures can be used to incorporate and use one or more embodiments. Further, different instructions, instruction formats, instruction fields and/or instruction values may be used. Yet further, although examples of values for abort codes and condition codes are provided, other values may be used. Moreover, different, other, and/or additional restrictions/constraints may be provided/used. Yet further, other intervals may be provided and/or used in differing ways. Many variations are possible.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description, but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A method for generating an automated control process for controlling a subsection of a utility grid of a power network, comprising:
determining a topology of the subsection of the utility grid by obtaining data describing functionalities of components of the subsection of the utility grid and relationships between the components, wherein the subsection of the utility grid comprises one or more potential utility subgrids;
identifying an event type in the power network which will trigger a requirement for implementing a configuration change to the subsection of the utility grid;
generating, based on the topology, an automated control process for directing the configuration change in the subsection of the utility grid should an event of the event type occur; and
automatically distributing to at least one controller associated with the power network the automated control process, wherein the at least one controller monitors, at least in part, the power network, and initiates the configuration change using the automated control process based on identifying occurrence of the event of the event type.

2. The method of claim 1, wherein determining the topology further comprises:
analyzing the obtained data to determine if the obtained data is sufficient to generate the automated control process for the subsection of the utility grid, the determining comprising:
ascertaining that the obtained data comprises rated capacities of the components of the subsection of utility grid;
ascertaining that the obtained data comprises identifications of communication protocols and datastreams of the components; and
ascertaining that the subsection of utility grid comprises breakers operable for load isolation, grounding, or islanding, based on the configuration change to be applied to the subsection of the utility grid.

3. The method of claim 1, wherein determining the topology further comprises:
analyzing the obtained data to determine if the obtained data is sufficient to generate the automated control process for the subsection of the utility grid, the determining comprising:
ascertaining that each component is associated with one or more electrical conductors in the subsection of utility grid; and
ascertaining that external controllers in the subsection of utility grid can be managed by the at least one controller.

4. The method of claim 1, wherein the event comprises at least one of an actual or expected loss of voltage, restoration of voltage, or a change in load in the power network, and the configuration change comprises one of: opening a breaker to disconnect the subsection of the utility grid from at least one utility feeder in the power network, or closing a breaker to connect the subsection of the utility grid to at least one utility feeder in the power network.

5. The method of claim 4, wherein the configuration change further comprises:
based on opening the breaker, tripping one or more load breakers in the subsection of the utility grid;
starting one or more local generators in the subsection of the utility grid; and
monitoring power generation of the one or more local generators to verify that the one or more potential utility subgrids in the subsection of the utility grid are operational.

6. The method of claim 4, wherein the configuration change further comprises:
based on closing the breaker, stopping one or more local generators in the subsection of the utility grid;
monitoring power generation of the one or more local generators to verify that the one or more local generators have stopped; and
based on the verifying, closing one or more load breakers in the subsection of the utility grid to reconnect one or more components in the subsection of the utility grid in the power network.

7. The method of claim 1, wherein the event comprises at least one of an actual or expected loss of voltage, restoration of voltage, or change in load in the power network, and the configuration change comprises enabling or disabling a component of the subsection of the utility grid.

8. The method of claim 7, wherein the component enabled or disabled comprises a power source and the event is a result of an operation change to a power load in the subsection of the utility grid.

9. The method of claim 1, wherein the components comprise at least one of: a power source, a power load, a switchgear, or an energy storage system.

10. A computer program product for generating an automated control process for controlling a subsection of a utility grid in a power network, comprising:
a computer readable storage medium readable by one or more processors and storing instructions for execution by the one or more processors for performing a method comprising:
determining a topology of the subsection of the utility grid by obtaining data describing functionalities of components of the subsection of the utility grid and relationships between the components, wherein the subsection of the utility grid comprises one or more potential utility subgrids;
identifying an event type in the power network which will trigger a requirement for implementing a configuration change to the subsection of the utility grid;
generating, based on the topology, an automated control process for directing the configuration change in the subsection of the utility grid should an event of the event type occur; and
automatically distributing to at least one controller associated with the power network the automated control process, wherein the at least one controller monitors, at least in part, the power network, and initiates the configuration change using the automated control process based on identifying occurrence of the event of the event type.

11. The computer program product of claim 10, wherein the determining the topology further comprises:
analyzing the obtained data to determine if the obtained data is sufficient to generate the automated control process for the subsection of the utility grid, the determining comprising:
ascertaining that the obtained data comprises rated capacities of the components of the subsection of utility grid;
ascertaining that the obtained data comprises identifications of communication protocols and datastreams of the components; and
ascertaining that the subsection of utility grid comprises breakers operable for load isolation, grounding, or islanding, based on the configuration change to be applied to the subsection of the utility grid.

12. The computer program product of claim 10, wherein the determining the topology further comprises:
analyzing the obtained data to determine if the obtained data is sufficient to generate the automated control process for the subsection of the utility grid, the determining comprising:
ascertaining that each component is associated with one or more electrical conductors in the subsection of utility grid; and
ascertaining that external controllers in the subsection of utility grid can be managed by the at least one controller.

13. The computer program product of claim 10, wherein the event comprises at least one of an actual or expected loss of voltage, restoration of voltage, or change in load in the power network, and the configuration change comprises one of: opening a breaker to disconnect the subsection of the utility grid from at least one utility feeder in the power network, or closing a breaker to connect the subsection of the utility grid to at least one utility feeder in the power network.

14. The computer program product of claim 13, wherein the configuration change further comprises:
based on opening the breaker, tripping one or more load breakers in the subsection of the utility grid;
starting one or more local generators in the subsection of the utility grid; and
monitoring power generation of the one or more local generators to verify that the one or more potential utility subgrids in the subsection of the utility grid are operational.

15. The computer program product of claim 13, wherein the configuration change further comprises:
based on closing the breaker, stopping one or more local generators in the subsection of the utility grid;
monitoring power generation of the one or more local generators to verify that the one or more local generators have stopped; and
based on the verifying, closing one or more load breakers in the subsection of the utility grid to reconnect one or more components in the subsection of the utility grid in the power network.

16. The computer program product of claim 10, wherein the event comprises at least one of an actual or expected loss of voltage, restoration of voltage, or change in load in the power network, and the configuration change comprises enabling or disabling a component of the subsection of the utility grid.

17. The computer program product of claim 16, wherein the component enabled or disabled comprises a power source and the event is a result of an operation change to a power load in the subsection of the utility grid.

18. A system for automated control of a subsection of a utility grid in a power network, the system comprising:
a utility grid in a power network comprising a subsection, the subsection comprising one or more potential utility subgrids, the subsection further comprising components;
one or more processors in communication with one or more memories, the one or more processors being communicatively coupled to the one or more memories to generate an automated control process for directing a configuration change in the subsection of the utility grid and to automatically distribute the automated control process at least one controller associated with the power network, the generating the automated control process comprising:
determining a topology of the subsection of the utility grid by obtaining data describing functionalities of the components of the subsection of the utility grid and relationships between the components;
identifying an event type in the power network which will trigger a requirement for implementing a configuration change to the subsection of the utility grid should an event of the event type occur; and
generating, based on the topology, the automated control process;
and
the at least one controller accessing the automated control process, and monitoring, at least in part, the power network, and initiating the configuration change using the automated control process based on identifying an occurrence of the event of the event type.

19. The system of claim 18, further comprising:
a utility feeder to supply power to the subsection; and
a breaker in the subsection to connect or disconnect the subsection of the utility grid from the utility feeder, wherein the event comprises an actual or expected loss of voltage, restoration of voltage, or change in load in the power network, and the configuration change comprises opening or closing the breaker to disconnect the subsection of the utility grid from the utility feeder.

20. The system of claim 19, the subsection of the utility grid further comprising:
a load breaker coupled to the breaker; and
a local generator coupled to the local breaker, wherein the configuration change further comprises one of:
based on opening the breaker, tripping the load breaker, starting the local generator, and monitoring power generation of the local generator to verify that the one or more utility subgrids in the subsection of the utility grid are operational; or
based on closing the breaker, stopping the local generator, monitoring power generation of the local generator to verify that the local generator has stopped; and closing the load breaker to reconnect components in the subsection of the utility grid.
